(19) United States
(12) Patent Application Publication
(10) Pub. No.: US 2026/0312327 A1
(43) Pub. Date: Oct. 8, 2026

(54) CONNECTOR

(71) Applicant: Stäubli Electrical Connectors AG, Allschwil (CH)

(72) Inventors: Lukas GAENZLE, Steinen (DE); Andreas WENIGER, Weil am Rhein (DE)

(73) Assignee: Stäubli Electrical Connectors AG, Allschwil (CH)

(21) Appl. No.: 19/481,753

(22) PCT Filed: May 6, 2024
(86) PCT No.: PCT/EP2024/062394

§ 371 Date: Nov. 5, 2025

(30) Foreign Application Priority Data
May 9, 2023 (EP) 23172179.6

(51) Int. Cl. H01R 13/426; H01R 43/20

(52) U.S. Cl. CPC H01R 13/426; H01R 43/20

(57) ABSTRACT

A connector including a housing with an interior space, an electrical contact element arranged in the interior space and including a contact section and a connection section, and a first securing element and a second securing element. The housing includes at least one first housing-side receiving structure and at least one second housing-side receiving structure. The contact element includes a first contact element-side receiving structure and a second contact element-side receiving structure. When the contact element is inserted, the contact element is fixed to the housing by the first securing element. When the contact element is inserted, the second securing element engages with the second housing-side receiving structure and with the second contact element-side receiving structure in such a way that the contact element is fixed to the housing by the second securing element.

### TECHNICAL FIELD

The present invention relates to a connector according to claim 1 and a method for assembling said connector according to claim 17.

### PRIOR ART

Connectors have become known from the prior art.

### SUMMARY OF THE INVENTION

The present invention is based on the task of providing a connector with a contact element that has improved properties. In particular, the securing, positioning, and mounting, respectively, of the contact element in the housing should be improved.

The connector according to claim 1 solves these and other problems. Accordingly, a connector comprises a housing with an interior space bounded by a side wall, an electrical contact element arranged in the interior space with a contact section and a connection section, as well as a first securing element and a second securing element. The housing comprises at least one first housing-side receiving structure and at least one second housing-side receiving structure. Furthermore, the contact element comprises a first contact element-side receiving structure and a second contact element-side receiving structure. When the contact element is inserted, the first securing element engages with the first housing-side receiving structure and with the first contact element-side receiving structure in such a way that the contact element is fixed to the housing by the first securing element. When the contact element is inserted, the second securing element engages with the second housing-side receiving structure and with the second contact element-side receiving structure in such a way that the contact element is secured to the housing by the second securing element.

The arrangement of two securing elements, both of which secure the contact element to the housing, has the advantage that the safety against unintentional disconnection can be increased.

The contact section serves to provide an electrical contact between the electrical contact element and a further contact element in another connector that can be connected to the connector according to the claims.

The contact section can be designed as a socket opening or as a plug pin.

The connection section serves to connect a cable to the contact element.

The term “fixed” means that the contact element is firmly connected to the housing or securely fastened to the housing by the securing element, respectively.

The terms “first securing element” and “second securing element” merely refer to two different securing elements. The words ‘first’ and “second” serve to define and assign characteristics to the respective securing element and do not indicate the order of assembly.

The interior space comprises a shape into which the contact element can be inserted in the correct position. The shape of the interior space is designed to be complementary or compatible respectively with the contact element in sections.

Preferably, the first securing element protrudes partially from the interior space and is thus accessible from outside the housing. Preferably, the second securing element is located completely inside the interior space.

Preferably, the side wall comprises at least one recess through which the first securing element protrudes from the interior space. Preferably, an actuating section of the securing element is located outside the housing when the securing element is inserted. Preferably, the actuating section can be gripped by a tool, so that a force can be applied with the tool to remove the first securing element. Alternatively, the first securing element can be gripped and removed without the aid of a tool.

The second securing element is preferably accessible through a recess in the side wall. For example, a tool can be inserted into the interior space through the recess in order to release the connection between said securing element and the housing or the contact element, respectively.

This arrangement has the advantage that the first securing element can be removed and the other securing element continues to fix or secure the contact element to the housing. The fact that the second securing element is located inside the housing has the advantage that the connection between the contact element and the housing cannot be accidentally disconnected; instead, a specialist must use a corresponding tool.

Preferably, at least one of the two securing elements provides a form-fit connection between the housing and the contact element.

The corresponding securing element therefore engages positively with the respective housing-side receiving structure and the respective contact element-side receiving structure.

Preferably, the first securing element is spaced apart from the contact section. Preferably, the second securing element at least partially surrounds the contact section.

Preferably, the shape of the contact section defines a plug-in direction, wherein the first securing element can be inserted into the first housing-side receiving structure and into the first contact element-side receiving structure in the plug-in direction; and wherein the second securing element can be inserted into the housing in a direction transverse to the plug-in direction.

Preferably, the first securing element is designed separately from the contact element in such a way that the engagement between the first securing element and the contact element and the housing can only be provided after the contact element has been inserted into the interior space. This means that the first securing element can only be engaged with the first housing-side receiving structure and with the first contact element-side receiving structure when the contact element is inserted.

In a first preferred variant, the second securing element is connected to the contact element in such a way that the second securing element and the contact element can be inserted into the interior space together, wherein the engagement between the second securing element and the contact element can be provided before the contact element is inserted into the interior space and wherein the engagement between the second securing element and the housing can be provided during the insertion of the contact element. This means that the second securing element is already engaged with the second contact element-side receiving structure before insertion into the interior space and is brought into engagement with the second housing-side receiving structure during insertion into the interior space.

In a second preferred variant, the second securing element is connected to the housing in such a way that the engagement between the second securing element and the housing can be provided before the contact element is inserted into the interior space and that the engagement between the second securing element and the contact element can be provided during the insertion of the contact element. This means that the second securing element is already engaged with the second housing-side receiving structure before insertion into the interior space and is engaged with the second contact element-side receiving structure during insertion into the interior space.

Preferably, the first securing element comprises at least one securing section, wherein said securing section engages both the first housing-side receiving structure and the first contact-side receiving structure.

Preferably, the securing section of the first securing element is designed as a rigid securing section.

The term “rigid securing section” is understood such that no deformation of the rigid securing section is intended during the intended insertion of the securing element.

Preferably, the at least one securing section comprises essentially or predominantly a cylindrical shape, wherein the cylindrical shape preferably comprises a circular or an oval cross-section. The first housing-side receiving structure, in which the securing section engages, comprises a cross-section that is designed to match the cross-section of the cylindrical shape.

Preferably, the first securing element comprises two securing sections spaced apart from each other.

Preferably, the first securing element comprises at least one latching structure, by means of which the first securing element can be latched to the housing and/or to the contact element. To disassemble the first securing element, a force must be applied to release the latching connection.

Preferably, the second securing element comprises at least two securing sections, wherein at least one of the at least two securing sections engages in the second housing-side receiving structure and wherein at least one other of the at least two securing sections engages in the second contact element-side receiving structure.

Preferably, the at least two securing sections of the second securing element are spring-elastic, in particular in the form of spring-elastic latching tabs. Therein, said receiving structures are formed as recesses on the housing or on the contact element, respectively, with the latching tabs engaging in the latching recesses.

Preferably, the at least two securing sections are designed as spring-elastic latching tabs, and the spring-elastic latching tabs are oriented with respect to the direction in which the contact element can be inserted into the housing in such a way that the latching tabs are pivoted in a spring-loaded manner from their initial position during the insertion process. Preferably, the locking tabs spring back to their initial position when they reach the respective receiving structure and engage in the respective receiving structure.

Preferably, the second securing element comprises a U-shaped form with a base leg and two side legs extending from the base leg, wherein the securing sections are arranged on the side legs.

Preferably, the contact element comprises bearing surfaces on which the base leg and/or the side legs bear flat against the contact element.

Preferably, the base leg and the bearing surface are formed in a rounded manner with a rounding at the point where the base leg comes to rest.

Preferably, the side legs are designed as straight tabs and the bearing surfaces on which the tabs come to rest are designed as flat bearing surfaces.

Preferably, the first securing element extends across the interior space in such a way that, when the first securing element is inserted into the first housing-side receiving structure before the contact element is inserted, an insertion of the contact element can be prevented.

A method for assembling a connector as described above,
wherein, in a first step, the second securing element is connected to the housing or to the contact element,
wherein, in a second step, the contact element is inserted into the housing, wherein, after insertion of the contact element, the contact element is secured to the housing by engagement of the second securing element in the second housing-side receiving structure and in the second contact element-side receiving structure; and
wherein in a third step, the first securing element is inserted into the first housing-side receiving structure and into the first contact element-side receiving structure, wherein, after insertion of the first securing element, the contact element is additionally secured to the housing by the first securing element.

It is particularly preferred that the second securing element is already located on the contact element during assembly, wherein the second securing element engages in the second contact element-side receiving structure. When the contact element has reached the correct position in the housing, the second securing element engages with the second housing-side receiving structure, thereby securing the contact element to the housing via the second securing element.

Further embodiments are specified in the dependent claims.

### BRIEF DESCRIPTION OF THE DRAWINGS

Preferred embodiments of the invention are described below with reference to the drawings, which are for illustrative purposes only and should not be construed as limiting. The drawings show, in:

FIG. 1 a perspective view of a connector according to an embodiment of the present invention prior to assembly;

FIG. 2 a perspective view of a connector according to FIG. 1 during assembly;

FIG. 3 a perspective view of a connector according to FIG. 1 after assembly;

FIG. 4 a partially sectioned view of the connector of the preceding figures; and

FIG. 5 a sectional view along section line IV-IV of FIG. 4.

### DESCRIPTION OF PREFERRED EMBODIMENTS

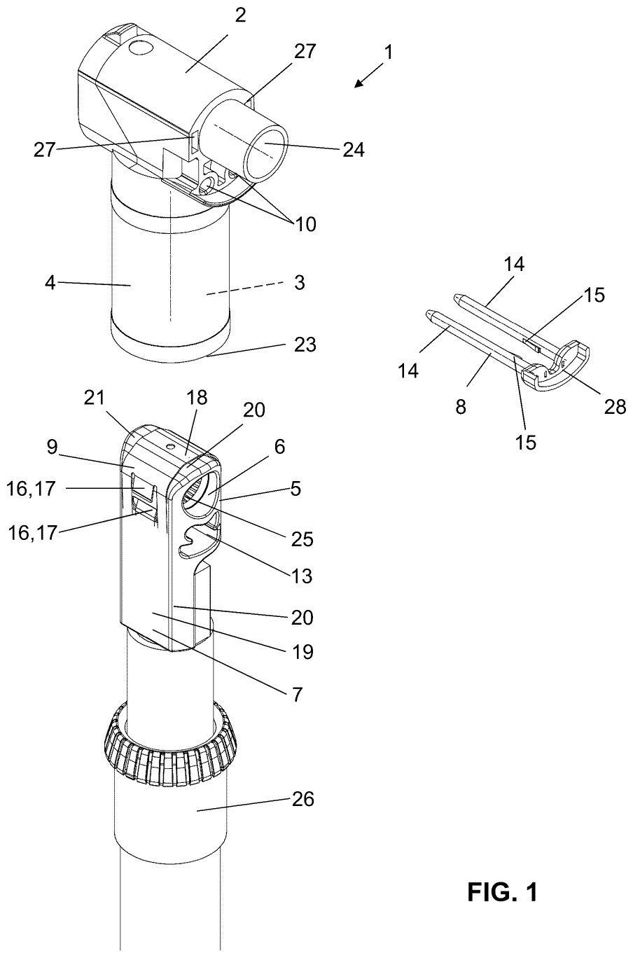

The figures show a connector 1 according to one embodiment of the present invention. As can be seen in FIG. 1, the connector 1 comprises a housing 2, an electrical contact element 3, a first securing element 8, and a second securing element 9. The two securing elements 8, 9 are designed to hold or secure the contact element 5 in the interior space 3.

The housing 2 comprises an interior space 3 which is bounded on the outside by a side wall 4. The contact element 5 is inserted into the interior space 3 and the housing 2 surrounds the contact element 5 on the outside when it is inserted. The housing 2 essentially comprises two access openings 23, 24. The contact element 5 can be inserted into the interior space 3 via the one access opening with the reference number 23. A contact element of another connector not shown in the figures can be guided to the contact element 5 via the other access opening with the reference number 24.

The electrical contact element 5 comprises a contact section 6 and a connection section 7. The contact section 6 is designed as a socket here. A contact part 25 is arranged in the socket here, which establishes an electrical contact between the socket shown here and a plug pin that protrudes into the socket. However, the contact section 6 can also be designed as a plug pin. Here, an electrically conductive cable 26 is arranged at the connection section 7.

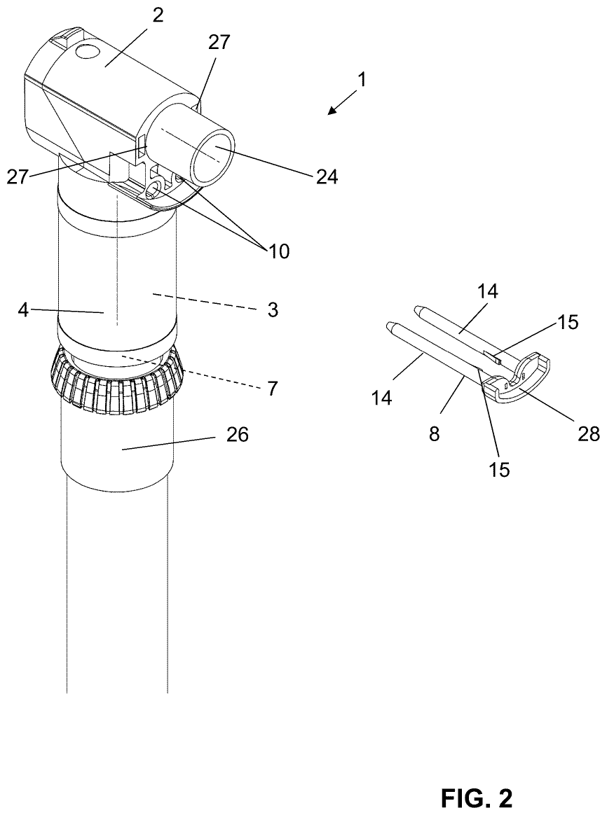

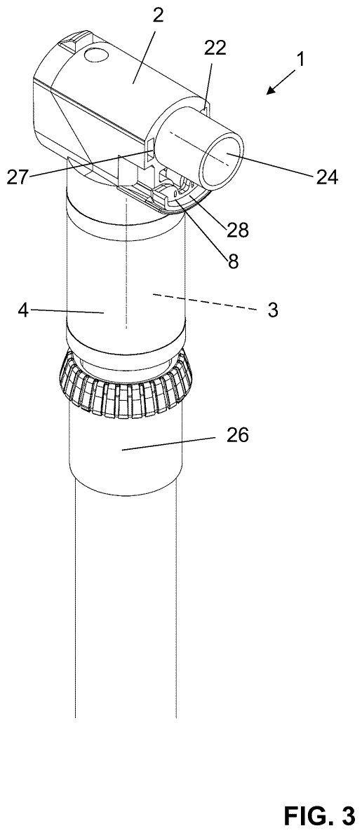

Starting from the position shown in FIG. 1, the contact element 5 is inserted into the interior space 3. FIG. 2 shows the contact element 5 in the inserted state. In the inserted state, the first securing element 8 is not yet in engagement with the housing 2 or the contact element 3, respectively, while the second securing element 9 is already in contact with the housing 2 and the contact element 5. When the contact element 5 is in the inserted state, the first securing element 8 can be inserted starting from the position shown in FIG. 2. FIG. 3 shows the first securing element 8 in the securing position, such that the first securing element 8 secures the contact element 5 to the housing 2. During assembly, engagement via the second securing element 9 is provided first, followed by engagement via the first securing element 8.

It can be seen from FIG. 3 that the first securing element 8 protrudes partially from the interior space 3 and that parts of the first securing element 8 are accessible from outside the housing 2. This part can be grasped by a user so that the first securing element 8 can be separated from the housing 2 or from the contact element 5, respectively.

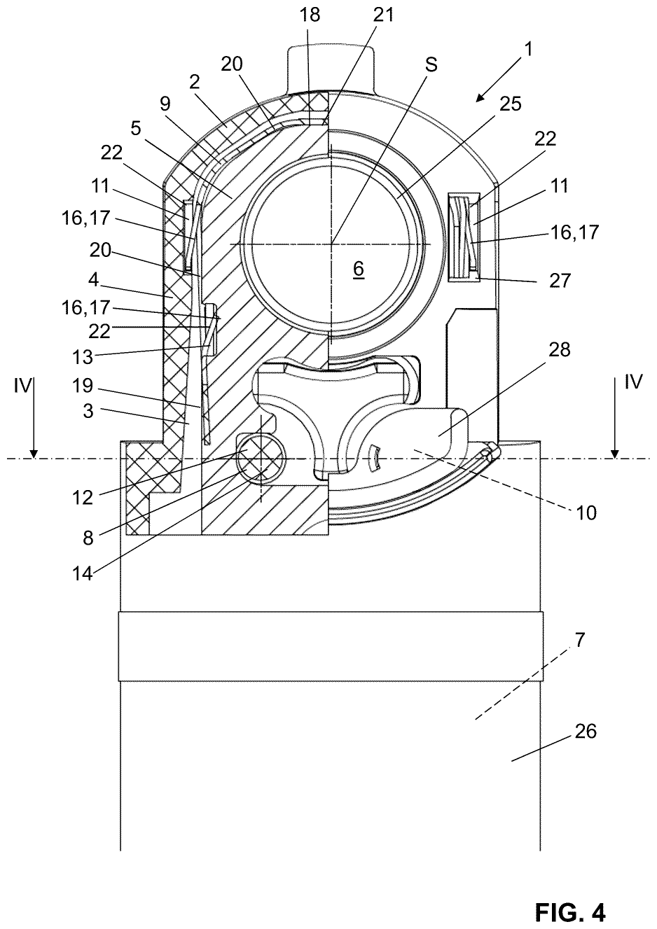

The second securing element 9 lies completely within the interior space 3 of the housing 2. The housing 2 may optionally have at least one recess 27 through which the second securing element 9 is accessible, so that the connection between the housing 2 and the contact element 5 established by the second securing element 9 can be released. In the embodiment shown, two recesses 27 are arranged laterally to the contact section 6. Reference is made in this regard to FIG. 4, where the recesses 27 are shown.

Preferably, both the first securing element 8 and the second securing element 9 are designed in such a way that a form-fit connection is provided between the housing 2 and the contact element 5.

FIG. 4 shows a partially cutaway view of the connector 1. The first securing element 8 is spaced apart from the contact section 6 and engages the contact element 5 between the contact section 6 and the connection section 7. In other words, this means that the first contact element-side receiving structure 12 is located between the contact section 6 and the connection section 7. The connection section 7 in FIG. 4 is covered by the side wall 4.

The second securing element 9 rests on bearing surfaces 20 located on the exterior side of the contact element 5 and at least partially surrounds the contact section 6. In other words, this means that the second contact element-side receiving structure 13 is located on an exterior side of the contact element 5.

The shape of the contact section 6 defines a plug-in direction S. In FIG. 4, the plug-in direction S runs at right angles to the plane of the drawing sheet. In the embodiment shown, the first securing element 8 is arranged such that it can be inserted into the first housing-side receiving structure 10 and into the first contact element-side receiving structure 12 in a direction parallel to the plug-in direction.

As can be seen from the figures, the first securing element 8 is designed separately from the contact element 5, so that the engagement between the first securing element 8 and the contact element 5 and the housing 2 can only be provided after the contact element 5 has been inserted into the interior space 3. This means that the securing element 8 can only be engaged after the contact element 5 has been inserted into the respective first housing-side receiving structure 10 and the first contact element-side receiving structure 12. The first securing element 8 extends across the interior space 3 in such a way that if the first securing element 8 is inserted into the first housing-side receiving structure 10 before the contact element 5 is inserted, an insertion of the contact element 5 can be prevented.

As can be seen from the figures, in particular from FIG. 1, the second securing element 9 is connected to the contact element 5, so that the second securing element 9 and the contact element 5 can be inserted together into the interior space 3. The engagement between the second securing element 9 and the contact element 5 can be provided before the contact element 5 is inserted into the interior space 3, and the engagement between the second securing element 9 and the housing 2 can be provided when the contact element 5 is inserted into the interior space 3. This means that the engagement between the securing element 9 and the second contact element-side receiving structure 13 is provided before the contact element 5 is inserted into the interior space, and that the engagement between the second securing element 9 and the second housing-side receiving structure 11 is provided during insertion of the contact element 5.

The preferred design of the first securing element 8 shown in the figures is now described in more detail with reference to FIGS. 1 to 5.

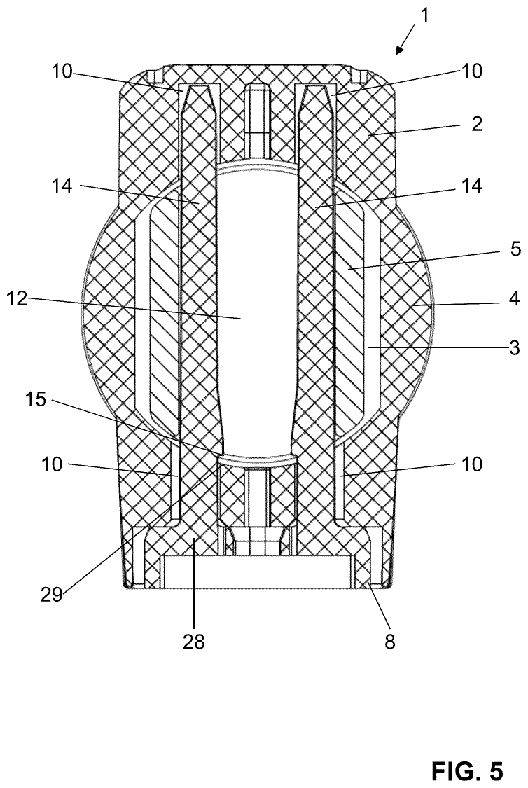

Preferably, the first securing element 8 has at least one securing section 14. In the embodiment shown, two securing sections 14 are provided. The at least one securing section 14 engages both the first housing-side receiving structure 10 and the first contact element-side receiving structure 12. The engagement is shown in the sectional view in FIG. 5. The at least one securing section 14 extends through the first contact element-side receiving structure 12 and engages with the housing-side receiving structure 10. Here, sections of the housing-side receiving structure 10 are located on both sides of the contact element 5.

The at least one securing section 14 of the first securing element 8 is preferably designed as a rigid securing section 14.

The at least one securing section 14 is followed by an actuating section 28, which is the part of the first securing element 8 that is accessible from outside the housing 2 when the securing element 8 is inserted.

As mentioned, the first securing element 8 has two securing sections 14 spaced apart from each other. The two spaced-apart securing sections 14 extend away from said actuating section 28 and run parallel to each other.

Preferably, the at least one securing section 14 comprises a substantially cylindrical shape, wherein the cylindrical shape preferably comprises a circular or an oval cross-section, and the first housing-side receiving structure 10, in which the securing section 14 engages, comprises a cross-section that is designed to match the cross-section of the cylindrical shape. The first contact element-side receiving structure 12 may also comprise a corresponding shape. In the embodiment shown, the contact element-side receiving structure 12 is designed such that both securing sections 14 extend through the single contact element-side receiving structure 12.

Furthermore, the first securing element 8 comprises at least one optional latching structure 15. This latching structure 15 is arranged here on the at least one securing section 14. FIG. 5 shows the interaction of the at least one latching structure 15 with the housing 2. The at least one locking structure 15 engages a stop edge 29 of the housing 2. In more general terms, the first securing element 8 with its locking structure 15 can be latched to the housing 2. In other embodiments, the first securing element 8 can also be latched to the contact element 5.

The preferred embodiment of the second securing element 9 shown in the figures is now described in more detail with reference to FIGS. 1 to 5.

The second securing element 9 comprises at least two securing sections 16. The securing sections 16 can be seen in FIGS. 1 and 4. At least a first of the at least two securing sections 16 engages with the second housing-side receiving structure 11 and at least one further of the at least two securing sections 16 engages with the second contact element-side receiving structure 13. In the embodiment shown, in each case a first and a further securing section 16 are arranged on both sides of the contact section 6.

Preferably, the at least two securing sections 16 are spring-elastic, in particular in the form of spring-elastic latching tabs 17. The second housing-side receiving structure 11 and the second contact element-side receiving structure 13 are designed as latching recesses 22 into which the latching tabs 17 engage.

The spring-elastic latching tabs 17 are oriented with respect to the direction in which the contact element 5 can be inserted into the housing 2 in such a way that the latching tabs 17 are pivoted in a spring-loaded manner from their initial position during the insertion process and that the latching tabs 17 spring back to their initial position when they reach the respective receiving structure 11, 13, and engage in the respective receiving structure 11, 13. This engagement fixes the contact element 5 to the housing 2.

Preferably, the second securing element 9 comprises a U-shaped form with a base leg 18 and two side legs 19 extending from the base leg 18. The securing sections 16 are arranged on the side legs 19. The contact element 5 comprises bearing surfaces 20 on which the base leg 18 and/or the side legs 19 bear flat against the contact element 5. The base leg 18 and the bearing surface 20 are formed in a rounded manner with a rounding 21 at the point where the base leg 18 comes to rest. The side legs 19 are designed as straight tabs and the bearing surfaces 20 on which the tabs come to rest are designed as flat bearing surfaces 20.

The first securing element 8 and the housing 2 are preferably made of an electrically non-conductive material, such as a plastic material. The second securing element 9 is preferably made of spring steel. The contact element 5 is made of an electrically conductive material.

A method for assembling a connector as described above is characterized in that
in a first step, the second securing element 9 is connected to the housing 2 or to the contact element 5,
in a second step, the contact element 5 is inserted into the housing 2, wherein, after the contact element 5 has been inserted, the contact element 5 is secured to the housing 2 by the second retaining element 9 engaging in the second housing-side receiving structure 11 and in the second contact element-side receiving structure 13; and that
in a third step, the first securing element 8 is inserted into the first housing-side receiving structure 10 and into the first contact element-side receiving structure 12, wherein after insertion of the first securing element 8, the contact element 5 is additionally secured to the housing 2 by the first securing element 8.

### LIST OF REFERENCE SIGNS

1 Connector
2 Housing
3 Interior space
4 Side wall
5 Contact element
6 Contact section
7 Connection section
8 First securing element
9 Second securing element
10 First housing-side receiving structure
11 Second housing-side receiving structure
12 First contact element-side receiving structure
13 Second contact element-side receiving structure
14 Securing section of first securing element
15 Latching structure
16 Securing section of second securing element
17 Latching tabs
18 Base leg
19 Side leg
20 Bearing surfaces
21 Rounding
22 Latching recess
23 Access opening
24 Access opening
25 Contact part
26 Cable
27 Recess
28 Actuating section
29 Stop edge

1-17. (canceled)

18. A connector comprising:
a housing with an interior space bounded by a side wall,
an electrical contact element which is arranged in the interior space and comprises a contact section and a connection section, as well as
a first securing element and a second securing element,
wherein the housing comprises at least one first housing-side receiving structure and at least one second housing-side receiving structure,
wherein the contact element comprises a first contact element-side receiving structure and a second contact element-side receiving structure,
wherein, when the contact element is inserted, the first securing element engages with the first housing-side receiving structure and with the first contact element-side receiving structure in such a way that the contact element is fixed to the housing by the first securing element; and
wherein, when the contact element is inserted, the second securing element engages with the second housing-side receiving structure and with the second contact element-side receiving structure in such a way that the contact element is fixed to the housing by the second securing element.

19. The connector according to claim 18, wherein the first securing element protrudes partially from the interior space and is thus accessible from outside the housing and/or wherein the second securing element is located completely within the interior space of the housing.

20. The connector according to claim 18, wherein at least one of the two securing elements provides a form-fit connection between the housing and the contact element.

21. The connector according to claim 18, wherein the first securing element is spaced apart from the contact section and/or wherein the second securing element at least partially surrounds the contact section.

22. The connector according to claim 18, wherein the shape of the contact section defines a plug-in direction, wherein the first securing element can be inserted into the first housing-side receiving structure and into the first contact element-side receiving structure in a direction parallel to the plug-in direction; and wherein the second locking element can be inserted into the housing in a direction transverse to the plug-in direction.

23. The connector according to claim 18,
wherein the first securing element is formed separately from the contact element in such a way that the engagement between the first securing element and the contact element and the housing can only be provided after the contact element has been inserted into the interior space; and/or
wherein the second securing element is connected to the contact element in such a way that the second securing element and the contact element can be inserted together into the interior space, wherein the engagement between the second securing element and the contact element can be provided before the contact element is inserted into the interior space and that the engagement between the second securing element and the housing can be provided during the insertion of the contact element; and/or
wherein the second securing element is connected to the housing in such a way that the engagement between the second securing element and the housing can be provided before the contact element is inserted into the interior space and that the engagement between the second securing element and the contact element can be provided during the insertion of the contact element.

24. The connector according to claim 18, wherein the first securing element comprises at least one securing section, wherein said securing section engages both the first housing-side receiving structure and the first contact element-side receiving structure.

25. The connector according to claim 24, wherein the securing section of the first securing element is formed as a rigid securing section; and/or wherein the first locking element comprises two securing sections spaced apart from each other.

26. The connector according to claim 24, wherein the at least one securing section comprises a cylindrical shape, wherein the cylindrical shape preferably comprises a circular or oval cross-section, and wherein the first housing-side receiving structure, in which the securing section engages, comprises a cross-section that is formed to match the cross-section of the cylindrical shape.

27. The connector according to claim 24, wherein the securing section of the first securing element is formed as a rigid securing section; and/or wherein the first locking element comprises two securing sections spaced apart from each other; and
wherein the securing section comprises a cylindrical shape, wherein the cylindrical shape preferably comprises a circular or oval cross-section, and wherein the first housing-side receiving structure, in which the securing section engages, comprises a cross-section that is formed to match the cross-section of the cylindrical shape.

28. The connector according to claim 18, wherein the first securing element comprises at least one latching structure, by means of which at least one latching structure the first securing element can be latched to the housing and/or to the contact element.

29. The connector according to claim 18, wherein the second securing element comprises at least two securing sections, wherein at least one of the at least two securing sections engages in the second housing-side receiving structure and wherein at least one other of the at least two securing sections engages in the second contact element-side receiving structure.

30. The connector according to claim 29, wherein the at least two securing sections are spring-elastic, in particular in the form of spring-elastic latching tabs.

31. The connector according to claim 29, wherein the at least two securing sections are formed as spring-elastic latching tabs, and wherein the spring-elastic latching tabs are oriented, with respect to the direction in which the contact element is insertable into the housing, such that the latching tabs are resiliently pivoted from their initial position during the insertion process, and that the latching tabs spring back to their initial position when they reach the respective receiving structure and engage in the respective receiving structure.

32. The connector according to claim 29, wherein the second securing element has a U-shaped form with a base leg and two side legs extending from the base leg, wherein the securing sections are arranged on the side legs.

33. The connector according to claim 29, wherein the second securing element has a U-shaped form with a base leg and two side legs extending from the base leg, wherein the securing sections are arranged on the side legs; and wherein the at least two securing sections are spring-elastic, in particular in the form of spring-elastic latching tabs.

34. The connector according to claim 29,
wherein the second securing element has a U-shaped form with a base leg and two side legs extending from the base leg, wherein the securing sections are arranged on the side legs, and
wherein the contact element comprises bearing surfaces on which the base leg and/or the side legs bear flat against the contact element; and/or
wherein the base leg and the bearing surface are formed in a rounded manner with a rounding at the point where the base leg comes to rest; and/or
wherein the side legs are formed as straight tabs and wherein the bearing surfaces on which the tabs come to rest are formed as flat bearing surfaces.

35. The connector according to claim 29, wherein the second securing element has a U-shaped form with a base leg and two side legs extending from the base leg, wherein the securing sections are arranged on the side legs; and wherein the at least two securing sections are spring-elastic, in particular in the form of spring-elastic latching tabs, and
wherein the contact element comprises bearing surfaces on which the base leg and/or the side legs bear flat against the contact element; and/or
wherein the base leg and the bearing surface are formed in a rounded manner with a rounding at the point where the base leg comes to rest; and/or
wherein the side legs are formed as straight tabs and wherein the bearing surfaces on which the tabs come to rest are formed as flat bearing surfaces.

36. The connector according to claim 18, wherein the first securing element extends transversely through the interior space in such a way that, when the first securing element is inserted into the first housing-side receiving structure before the contact element is inserted, an insertion of the contact element can be prevented.

37. A method for assembling a connector to claim 18, wherein:
in a first step, the second securing element is connected to the housing or to the contact element, wherein
in a second step, the contact element is inserted into the housing, wherein, after the contact element has been inserted, the contact element is secured to the housing by the second securing element engaging in the second housing-side receiving structure and in the second contact-side receiving structure; and wherein
in a third step, the first securing element is inserted into the first housing-side receiving structure and into the first contact element-side receiving structure, wherein after insertion of the first securing element, the contact element is additionally secured to the housing by the first securing element.
